(19) United States
(12) Patent Application Publication
(10) Pub. No.: US 2012/0202101 A1
(43) Pub. Date: Aug. 9, 2012

(54) THIN FLEXIBLE BATTERY

(75) Inventor: Tomohiro Ueda, Nara (JP)

(73) Assignee: Panasonic Corporation, Osaka (JP)

(21) Appl. No.: 13/502,073

(22) PCT Filed: Jun. 8, 2011
(86) PCT No.: PCT/JP2011/003247

§ 371 Date: Apr. 13, 2012

(30) Foreign Application Priority Data
Jun. 29, 2010 (JP) 2010-148184

(51) Int. Cl. H01M 4/66; H01M 4/02; H01M 2/02

(52) U.S. Cl. 429/127

(57) ABSTRACT

Disclosed is a thin flexible battery including: an electrode group which includes a positive electrode including a sheet-like positive electrode current collector with a positive electrode active material layer adhering to one surface thereof, a negative electrode including a sheet-like negative electrode current collector with a negative electrode active material layer adhering to one surface thereof, and an electrolyte layer interposed between the positive electrode active material layer and a lithium metal or lithium alloy; and a housing accommodating the electrode group. The housing includes a barrier layer, and resin layers formed on both surfaces thereof. The other surface of the positive electrode current collector and the other surface of the negative electrode current collector are in contact with the resin layer at an inner side of the housing, and have a surface roughness Rz1 of 0.05 to 0.3 μm.

### TECHNICAL FIELD

The present invention relates to a thin flexible battery including an electrode and a housing. The electrode includes a sheet-like current collector and an active material layer adhering to one surface of the current collector, with the other surface of the current collector being in contact with the housing.

### BACKGROUND ART

In recent years, thin batteries are used as power sources for small-sized electronic equipment such as cellular phones, voice recorder players, wristwatches, video and still cameras, liquid crystal displays, electronic desktop calculators, IC cards, temperature sensors, hearing aids, and pressure-sensitive buzzers.

Thin batteries are also used for devices that operate in contact with a living body. As one of such devices, a body-pasting device for injecting medicine through the skin of a living body into the body in response to the application of a predetermined potential thereto has been developed. Further, a sheet-like biological information signal generating device comprising: a measurement circuit for measuring biological information, such as the body temperature, blood pressure, and pulse; a monitor for monitoring the measured biological information; and a wireless transmission circuit for transmitting radio wave signals related to the biological information to facilities such as a hospital and a fire department has been developed. The biological information signal generating device is attached to the clothing of a user. In the case where the measured biological information shows an abnormality in health of the user, the biological information is automatically transmitted to a hospital and so on.

With increasing reduction in size of the above small-sized electronic equipment and devices, it is required to further reduce the thickness of thin batteries. In response to such requirement, a thin flexible battery including a housing made of a thin and flexible aluminum laminated film is proposed (e.g., Patent Literatures 1 and 2). The aluminum laminated film comprises an aluminum foil, and resin layers being formed on both surfaces of the aluminum foil and made of, for example, polyolefin. In such a thin battery, a pouch-like housing made of the aluminum laminated film accommodates an electrode group including a positive electrode, a negative electrode, and an electrolyte layer disposed between the positive electrode and the negative electrode. A pair of leads is connected to the electrode group, and is partially exposed outside as external terminals through a sealing portion of the housing.

Patent Literature 3 proposes a thin flexible battery including a current collector and a material mixture layer being formed on one surface of the current collector and including an active material, a binder, and a conductive agent, in which the surface roughness of the current collector is adjusted to 5 μm or less in order to improve the peeling strength between the current collector and the material mixture layer. By reducing the surface roughness of the current collector, the factor of generating a large stress locally in the current collector is reduced. This material mixture layer is obtained by applying a material mixture paste including an active material, a binder, and a conductive agent onto one surface of the current collector, and drying the paste, followed by compressing with rollers.

### CITATION LIST

### Patent Literature

[PTL 1] Japanese Laid-Open Patent Publication No. Hei 11-345599
[PTL 2] Japanese Laid-Open Patent Publication No. 2008-71732
[PTL 3] Japanese Laid-Open Patent Publication No. 2009-43703

### SUMMARY OF INVENTION

### Technical Problem

However, even though the surface roughness of the surface of the current collector in contact with the active material layer is controlled, the effect achieved thereby to reduce the stress generated in a thin battery is limited. In the case where a thin flexible battery is bent repeatedly, it is necessary to take into consideration the frictional force between the surface of the electrode current collector with no active material formed thereon and the smooth inner surface of the housing.

### Solution to Problem

One aspect of the present invention relates to a thin flexible battery including: an electrode group which includes a positive electrode including a sheet-like positive electrode current collector, and a positive electrode active material layer adhering to one surface of the positive electrode current collector, a negative electrode including a sheet-like negative electrode current collector, and a negative electrode active material layer adhering to one surface of the negative electrode current collector, and an electrolyte layer interposed between the positive electrode active material layer and the negative electrode active material layer; and a housing accommodating the electrode group, wherein

the housing includes a barrier layer, and resin layers formed on both surfaces of the barrier layer;

the other surface of the positive electrode current collector and the other surface of the negative electrode current collector are in contact with the resin layer at the inner side of the housing; and

the abovementioned other surface (hereinafter sometimes referred to as the “outside surface) of at least one of the positive electrode current collector and the negative electrode current collector has a surface roughness Rz1 of 0.05 to 0.3 μm.

Another aspect of the present invention relates to a thin flexible battery including: an electrode group which includes a first electrode including a sheet-like first current collector, and a first active material layer adhering to one surface of the first current collector, a second electrode including a sheet-like second current collector, and a second active material layer adhering to at least one surface of the second current collector, and an electrolyte layer interposed between the first active material layer and the second active material layer; and a housing accommodating the electrode group, wherein

the housing includes a barrier layer, and resin layers formed on both surfaces of the barrier layer,

the other surface of the first current collector is in contact with the resin layer at the inner side of the housing, and

the abovementioned other surface (the outside surface) of the first current collector has a surface roughness Rz1 of 0.05 to 0.3 μm.

### Advantageous Effects of Invention

According to the present invention, it is possible to provide a thin flexible battery with excellent bending resistance.

While the novel features of the invention are set forth particularly in the appended claims, the invention, both as to organization and content, will be better understood and appreciated, along with other objects and features thereof, from the following detailed description taken in conjunction with the drawings.

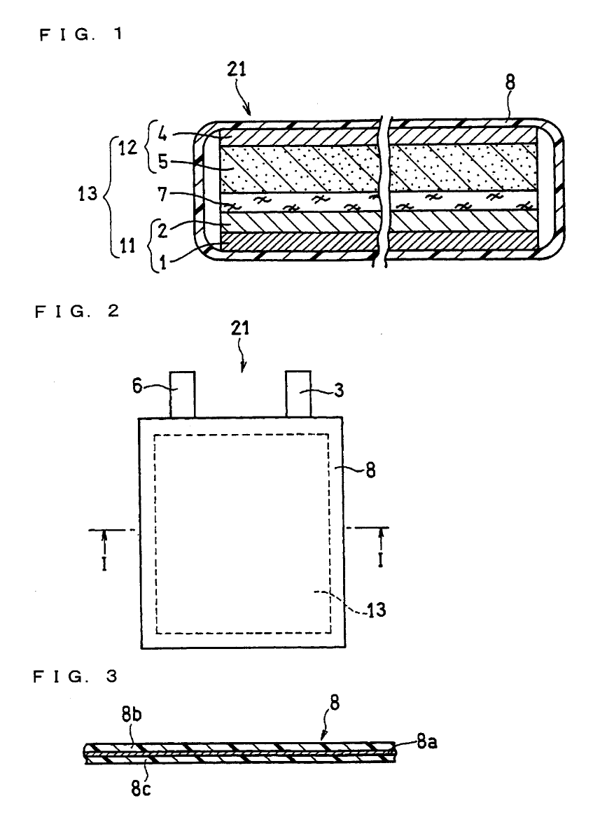

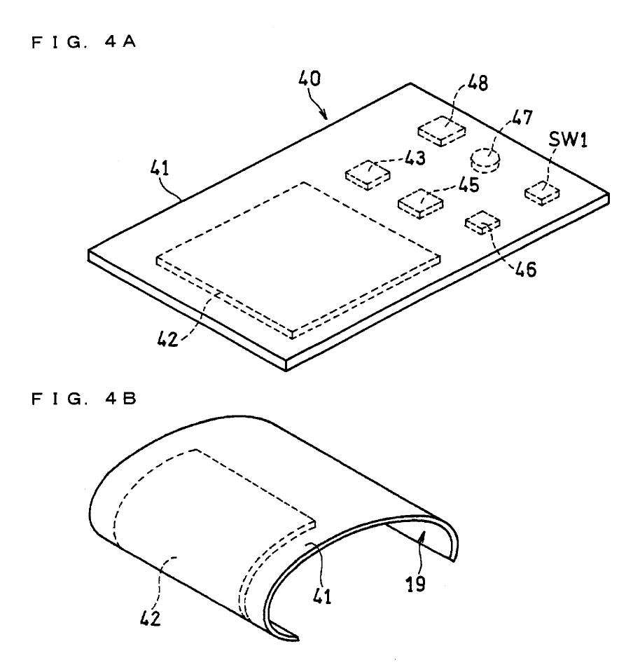

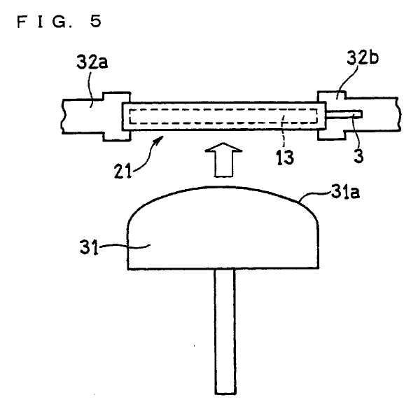

### BRIEF DESCRIPTION OF DRAWINGS

[FIG. 1] A schematic longitudinal cross-sectional view of a thin flexible battery according to one embodiment of the present invention.

[FIG. 2] A top view of the thin flexible battery according to one embodiment of the present invention.

[FIG. 3] A cross-sectional view of the laminated structure of a housing according to one embodiment of the present invention.

[FIG. 4A] An oblique view showing one example of a biological information measuring device.

[FIG. 4B] An oblique view showing one example of the appearance of the same biological information measuring device in a deformed state.

[FIG. 5] A view showing a battery and a jig in a bending test in Examples of the present invention.

### DESCRIPTION OF EMBODIMENTS

A thin flexible battery of the present invention includes: an electrode group which includes a positive electrode including a sheet-like positive electrode current collector, and a positive electrode active material layer adhering to one surface of the positive electrode current collector, a negative electrode including a sheet-like negative electrode current collector, and a negative electrode active material layer adhering to one surface of the negative electrode current collector, and an electrolyte layer interposed between the positive electrode active material layer and the negative electrode active material layer; and a housing accommodating the electrode group. Such a battery basically has a three-layer structure consisting of a positive electrode, an electrolyte layer, and a negative electrode (or a five-layer structure consisting of a positive electrode current collector, a positive electrode active material layer, an electrolyte layer, a negative electrode active material layer, and a negative electrode current collector). It should be noted, however, that the present invention does not exclude a thin flexible battery including an electrode group which further includes at least one positive electrode and at least one negative electrode between the positive and negative electrodes at both ends.

The housing is made of a highly flexible material with excellent bending resistance. Specifically, the housing is made of a sheet-like material including a barrier layer, and resin layers formed on both surfaces of the barrier layer. The thin flexible battery may be shaped like a flat plate or a curved plate. The thin flexible battery may be a primary battery or a secondary battery.

The other surface of the positive electrode current collector and the other surface of the negative electrode current collector are in contact with the resin layer at the inner side of the housing. In other words, the positive and negative electrodes have an active material layer on one surface thereof (hereinafter sometimes referred to as an “inside surface”), with the other surface thereof (the outside surface) being exposed. When a thin flexible battery having such a structure is bent repeatedly, frictional force is generated between the outside surface of the current collector and the smooth inner surface of the housing, and the current collector may be damaged. Further, when a large impact is applied to the thin flexible battery, a member connected to the current collector, such as a lead, may be damaged, or wrinkles may occur on the housing. In order to prevent these, the surface roughness Rz1 of the outside surface of the positive electrode current collector and/or the negative electrode current collector is controlled to 0.05 to 0.3 μm in the present invention.

The negative electrode active material layer of the present invention may be either a negative electrode material mixture layer including a negative electrode active material, a binder, and as needed, a conductive agent, or a metal sheet. In the case where the negative electrode active material layer is a sheet-like lithium metal or lithium alloy and comprises a negative electrode active material only, since the surface area of the sheet-like lithium metal or lithium alloy is much smaller than that of the material mixture layer, the adhesion strength thereof with the negative electrode current collector tends to be smaller. As such, if the surface roughness of the inside surface of the negative electrode current collector is reduced, the adhesion strength between the negative electrode active material layer and the negative electrode current collector becomes extremely small. Repeated bending of such a negative electrode causes separation of the negative electrode active material layer from the current collector, which increases the contact resistance between the negative electrode active material layer and the negative electrode current collect, resulting in a reduced capacity of the battery.

For this reason, in the case where the negative electrode active material layer is a sheet-like lithium metal or lithium alloy, the surface roughness Rz2 of the inside surface of the negative electrode current collector in contact with the negative electrode active material layer, is preferably 0.4 to 10 μm. By increasing the surface roughness as above of the negative electrode current collector being in contact with the negative electrode active material layer, the adhesion strength between the negative electrode active material layer and the negative electrode current collector is improved, which makes it possible to suppress the separation of the negative electrode active material layer from the current collector.

As described above, in one aspect of the present invention, importance is placed on optimizing individually the embodiment of the inside surface of the current collector, the surface being in contact with the active material layer, and the embodiment of the outside surface of the current collector, the surface being in contact with the resin layer at the inner side of the housing. For example, in the case where the negative electrode active material layer is a sheet-like lithium metal or lithium alloy, it is preferable to form the inside surface of the negative electrode current collector being in contact with the negative electrode active material layer, as a rough surface having a surface roughness Rz2 of 0.4 to 10 μm, and the outside surface thereof being in contact with the resin layer at the inner side of the housing, as a smooth surface having a surface roughness Rz1 of 0.05 to 0.3 μm. By configuring as above, the adhesion strength between the negative electrode current collector and the negative electrode active material layer can be improved, and at the same time, the slippage between the negative electrode current collector and the housing can be improved.

When the surface roughness of the outside surface of the negative electrode current collector exceeds 0.3 μm, the slippage between the outside surface and the inner surface of the smooth resin layer at the inner side of the housing is lowered. Due to the lowered slippage, an extremely large frictional force is generated between the negative electrode current collector and the housing, and stress is applied to the negative electrode current collector and a member connected thereto such as a negative electrode lead, which may cause damage thereto or cause wrinkles on the housing.

In view of improving the adhesion strength between the negative electrode current collector and the negative electrode active material layer, the thickness of the sheet-like lithium metal or lithium alloy is preferably 10 to 100 μm. Further, in order to obtain a high capacity battery with excellent bending resistance, the capacity per unit area of the negative electrode is preferably 1 to 10 mAh/cm².

The negative electrode current collector may be, for example, a metal film or metal foil. The negative electrode current collector is preferably incapable of alloying with lithium and excellent in electron conductivity. Therefore, the negative electrode current collector preferably includes at least one selected from the group consisting of copper, nickel, titanium, and stainless steel. For example, in the case where the negative electrode current collector is copper foil, the negative electrode current collector preferably has a thickness of 5 to 30 μm, and an elongation percentage of 5 to 15%.

The positive electrode active material layer is, for example, a material mixture layer including: at least one positive electrode active material selected from the group consisting of manganese dioxide, fluorinated carbon, a lithium-containing composite oxide, a metal sulfide, and an organic sulfur compound; a binder; and, as needed, a conductive agent. Since the adhesion strength of the material mixture layer with the current collector is comparatively high, the surface roughness Rz3 of the inside surface of the positive electrode current collector, the surface being in contact with the material mixture layer, may be, for example, 0.05 to 0.5 μm.

The positive electrode current collector may be a metal material, such as a metal film, metal foil, or non-woven fabric of metal fibers. The positive electrode current collector preferably includes at least one selected from the group consisting of silver, nickel, palladium, gold, platinum, aluminum, and stainless steel. The thickness of the positive electrode current collector is, for example, 1 to 30 μm.

The barrier layer constituting the housing is preferably an inorganic layer or metal layer, in view of the barrier performance, strength, bending resistance, and other properties. In particular, an aluminum layer is advantageous in its low production cost. The resin layer at the inner side of the housing preferably includes at least one selected from the group consisting of polyolefin, polyethylene terephthalate, polyamide, polyurethane, and ethylene-vinyl acetate copolymer, in view of the strength, impact resistance, electrolyte resistance, and other properties.

Another thin flexible battery according to the present invention includes an electrode group which includes: a first electrode including a sheet-like first current collector, and a first active material layer adhering to one surface of the first current collector; a second electrode including a sheet-like second current collector, and a second active material layer adhering to at least one surface of the second current collector; and an electrolyte layer interposed between the first active material layer and the second active material layer. In this battery also, the other surface of the first current collector is in contact with the resin layer at the inner side of the housing, and the surface roughness Rz1 of said the other surface is 0.05 to 0.3 μm. Basically, such a battery has a five-layer structure consisting of a pair of the first electrodes at the outermost layers, the second electrode at the inner layer, and two electrolyte layers interposed between the first electrode and the second electrode. It should be noted, however, that the present invention does not exclude a thin flexible battery including an electrode group having a five-or-more layer structure including at least one additional first electrode and at least one additional second electrode. Further, a thin flexible battery including an electrode group formed by winding one first electrode and one second electrode into a flat shape is not excluded.

A flexible battery according to one embodiment of the present invention is described with reference to FIGS. 1 and 2.

FIG. 1 is a longitudinal cross-sectional view of a thin flexible battery 21. FIG. 2 is a top view of the thin flexible battery 21. FIG. 1 corresponds to a cross-sectional view taken along the line I-I in FIG. 2. The thin flexible battery 21 includes an electrode group 13 and a housing 8 accommodating the electrode group 13. The electrode group 13 comprises a negative electrode 11, a positive electrode 12, and an electrolyte layer 7 (e.g., a separator impregnated with non-aqueous electrolyte) interposed between the negative electrode 11 and the positive electrode 12. The negative electrode 11 has a sheet-like negative electrode current collector 1 and a negative electrode active material layer 2 adhering to one surface of the negative electrode current collector 1. The positive electrode 12 has a sheet-like positive electrode current collector 4 and a positive electrode active material layer 5 adhering to one surface of the positive electrode current collector 4. The negative electrode 11 and the positive electrode 12 are arranged such that the positive electrode active material layer 5 and the negative electrode active material layer 2 face each other with the electrolyte layer 7 interposed therebetween. A negative electrode lead 3 is connected to the negative electrode current collector 1, and a positive electrode lead 6 is connected to the positive electrode current collector 4. The negative electrode lead 3 and the positive electrode lead 6 are partially exposed outside the housing 8, and the exposed portions function as a negative electrode terminal and a positive electrode terminal.

The housing 8 includes a barrier layer 8a and resin layers 8b and 8c formed on both surfaces thereof. One of the resin layers 8b and 8c is to be in contact with the exposed outside surfaces of the negative electrode current collector 1 and the positive electrode current collector 4.

Next, the negative electrode is specifically described.

The negative electrode active material layer 2 comprises a sheet-like lithium metal or lithium alloy. The lithium alloy may be, for example, a Li—Si alloy, Li—Sn alloy, Li—Al alloy, Li—Ga alloy, Li—Mg alloy, or Li—In alloy. In view of ensuring the capacity of the negative electrode, the ratio of element(s) other than Li in the lithium alloy is preferably 0.1 to 10% by weight. The negative electrode is obtained by press-fitting the negative electrode active material layer to the negative electrode current collector, thereby to allow the negative electrode current collector and the negative electrode active material layer to adhere each other. The negative electrode active material layer is deformed according to the magnitude of the pressure in press-fitting.

The inside surface of the negative electrode current collector 1, the surface being in contact with the negative electrode active material layer 2, preferably has a surface roughness Rz2 of 0.4 to 10 μm. The outside surface of the negative electrode current collector 1, the surface being in contact with the resin layer at the inner side of the housing 8, preferably has a surface roughness Rz1 of 0.05 to 0.3 μm. This can provide a highly reliable battery with excellent bending resistance.

When the inside surface of the negative electrode current collector being in contact with the negative electrode active material layer is rough as described above, an anchoring effect works, and good adhesion is obtained between the negative electrode current collector and the negative electrode active material layer. Concurrently therewith, when the outside surface of the negative electrode current collector being in contact with the resin layer at the inner side of the housing is smooth as described above, good slippage is obtained between the negative electrode current collector and the housing. As a result, even when the battery is bent repeatedly, stress is unlikely to be applied to the electrode group, and the high battery capacity can be maintained, without accompanying an increase in the contact resistance between the negative electrode current collector and the negative electrode active material layer.

By setting Rz2 to 0.4 μm or more, an excellent anchoring effect works between the negative electrode current collector and the negative electrode active material layer. By setting Rz2 to 10 μm or less, local stress is unlikely to be applied to the negative electrode current collector during bending of the battery, and damage to the negative electrode current collector is effectively prevented. In order to obtain more excellent adhesion between the negative electrode current collector and the negative electrode active material layer, the surface roughness Rz2 of the inside surface of the negative electrode current collector 1 being in contact with the negative electrode active material layer 2 is preferably 5 to 10 μm.

It is considered that a smaller Rz1 is more preferable. However, it is difficult to reduce Rz1 to less than 0.05 μm, in view of the processability of the negative electrode current collector. When Rz1 exceeds 0.3 μm, frictional force occurs between the negative electrode current collector and the housing during bending of the battery, which may cause wrinkles on the housing, or cause damage to the negative electrode current collector or the negative electrode lead. In order to obtain more excellent slippage between the negative electrode current collector and the housing, the surface roughness Rz1 of the outside surface of the negative electrode current collector 1 being in contact with the resin layer at the inner side of the housing 8 is more preferably 0.05 to 0.2 μm.

The “surface roughness” as used herein is a 10-point average roughness (Rz) specified by JIS Standard B0601. The 10-point average roughness (Rz) is a sum of: an average of absolute values of altitudes of the highest to the fifth highest peak from an average line in a profile curve taken by a length corresponding to the reference length L; and an average of absolute values of altitudes of the lowest to the fifth lowest valley from the average line.

The negative electrode current collector preferably includes at least one selected from the group consisting of copper, nickel, titanium, and stainless steel. Among these, the negative electrode current collector preferably includes copper because it is easily processed into a thin film and low in cost, and is preferably a copper foil or copper alloy foil.

The negative electrode current collector preferably has a thickness of 5 to 30 μm, in view of the bending resistance of the negative electrode current collector. By setting the thickness of the negative electrode current collector to 5 μm or more, the negative electrode current collector can maintain its excellent strength. By setting the thickness of the negative electrode current collector to 30 μm or less, the negative electrode current collector is imparted with more excellent flexibility, and large stress is unlikely to be generated in the negative electrode current collector during bending. As such, damage to the negative electrode current collector, such as cracks, is unlikely to occur. Further, by setting the thickness of the negative electrode current collector within the foregoing range, the ratio by volume of the negative electrode current collector in the battery can be kept small, which can ease the production of a thin flexible battery with high energy density.

In order to obtain a negative electrode current collector with excellent bending resistance, the negative electrode current collector preferably has an elongation percentage of 5 to 15%, and more preferably 5 to 10%. In this case, the negative electrode current collector can readily follow the deformation of the negative electrode during bending of the battery, and the separation of the negative electrode active material layer from the negative electrode current collector can be highly suppressed. In addition, the negative electrode current collector can have higher mechanical strength, and damage to the negative electrode current collector is highly suppressed.

The “elongation percentage” as used herein is a physical property measured at 25° C. using a flat plate-like test piece. It refers to a ratio of the change in length of the test piece along the plane direction thereof when a constant force is applied to the test piece until the test piece ruptures. The elongation in percentage of the negative electrode current collector is measured, for example, by a tensile test as below.

First, a test piece of 12.5 mm wide and 30 mm long (12.5 mm×30 mm) is prepared. The distance between gauge marks for measuring the length is set at 25 mm. For the tensile tester, a universal tester (Model 4505) available from Instron Corporation is used. The tensile rate is set at 0.5 mm/min. The elongation percentage is determined from the amount of change of the distance between gauge marks.

The elongation percentage of the negative electrode current collector can be controlled by heating the negative electrode current collector. The elongation percentage of the negative electrode current collector varies with changing the temperature or time of heating. Particularly, changing the heating temperature makes the control of the elongation percentage easy.

A preferable heating temperature is dependent on the material and desired elongation percentage of the negative electrode current collector, and is, for example, 60 to 600° C. In view of imparting the negative electrode current collector with high mechanical strength and excellent bending resistance, the heating temperature is more preferably 80 to 400° C., and furthermore preferably 80 to 200° C.

A preferable heating time is dependent on the heating temperature and a desired elongation percentage, and is, for example, 5 to 1440 minutes. A more preferable heating time is 10 to 120 minutes. When the heating time is too short, the elongation percentage may become difficult to control. When the heating time is too long, the productivity may be reduced.

The heating is preferably performed in a non-oxidizing atmosphere, in a reducing atmosphere, or in a vacuum, in view of preventing surface oxidation of the metal foil. Examples of the non-oxidizing atmosphere include an inert gas atmosphere of, for example, argon, helium, or krypton. Argon is particularly preferable because it is inexpensive. Examples of the reducing atmosphere include an argon gas atmosphere containing 2 to 10% hydrogen, preferably about 3% hydrogen, and a vacuum atmosphere.

The above heating may be followed by etching of the negative electrode current collector, for the purpose of removing an oxide film and foreign matters such as an organic matter from the surface of the negative electrode current collector. For example, in the case of directly forming a film of lithium metal or lithium alloy serving as an active material layer on the negative electrode current collector in a film forming system under reduced pressure or in a vacuum by sputtering or vacuum vapor deposition, it is preferable to etch the current collector in the film growing system, prior to the film formation.

The negative electrode active material layer preferably has a thickness of 10 to 100 μm, in view of the flexibility of the negative electrode active material layer. By setting the thickness of the negative electrode active material layer to 100 μm or less, the negative electrode active material layer can maintain its excellent flexibility, and the separation of the negative electrode active material layer from the negative electrode current collector which may occur during bending of the battery can be highly suppressed. By setting the thickness of the negative electrode active material layer to 10 μm or more, a battery with high energy density can be easily obtained. The “thickness of the negative electrode active material layer” as used herein is a thickness thereof in an undischarged state or in a charged state.

The negative electrode preferably has a capacity per unit area of 1 to 10 mAh/cm², in view of obtaining a high capacity battery with excellent bending resistance. By setting the capacity per unit area of the negative electrode to 10 mAh/cm² or less, the negative electrode active material layer will not be excessively thick. Further, the flexibility of the negative electrode active material layer is readily maintained. By setting the capacity per unit area of the negative electrode to 1 mAh/cm² or more, a battery with high energy density can be easily obtained. The “capacity per unit area of the negative electrode” as used herein is a value thereof in an undischarged state.

Next, the positive electrode is specifically described.

The positive electrode current collector preferably includes at least one selected from the group consisting of silver, nickel, palladium, gold, platinum, aluminum, and stainless steel. These may be used singly or in combination of two or more.

In the positive electrode current collector, at least the outside surface thereof in contact with the resin layer at the inner side of the housing 8 preferably has a surface roughness Rz1 of 0.05 to 0.3 μm. It is difficult to reduce Rz1 to less than 0.05 μm, in view of the processability of the positive electrode current collector. When Rz1 exceeds 0.3 μm, frictional force occurs between the positive electrode current collector and the housing during bending of the battery, which may cause wrinkles on the housing, or cause damage to the positive electrode current collector or the positive electrode lead.

The positive electrode active material layer is a material mixture layer being formed on one surface of the positive electrode current collector, and including a positive electrode active material, a binder, and, as needed, a conductive agent. The material mixture layer has good flexibility, and thus, can sufficiently follow the deformation of the positive electrode current collector during bending of the battery. Further, since the surface area of the material mixture layer is large, the surface roughness Rz3 of the inside surface of the positive electrode current collector being in contact with the positive electrode active material layer, may be set to, for example, 0.05 to 0.5 μm. By setting the surface roughness Rz3 of the inside surface within the foregoing range, the adhesion between the positive electrode current collector and the positive electrode active material layer can be sufficiently ensured. Further, local stress is unlikely to occur in the positive electrode current collector.

The positive electrode active material may be, for example, manganese dioxide, fluorinated carbon, a sulfide, a lithium-containing composite oxide, vanadium oxide, a lithium compound of vanadium oxide, niobium oxide, a lithium compound of niobium oxide, a conjugate polymer containing an organic conductive material, a Chevrel-phase compound, and an olivine-type compound. Among these, manganese dioxide, fluorinated carbon, a sulfide, and a lithium-containing composite oxide are preferable, and a positive electrode active material containing manganese dioxide as a principle component is particularly preferable. The positive electrode active material containing manganese dioxide as a principle component may further contain a material other than manganese dioxide, such as fluorinated carbon, vanadium oxide, or an olivine-type compound. The manganese dioxide may contain a small amount of impurities that have entered in the production process.

Given that the reaction of manganese dioxide in the battery is a one-electron reaction, the theoretical capacity per mass of the positive electrode active material is 308 mAh/g, which is a high capacity. In addition, manganese dioxide is inexpensive. Among various manganese dioxides, electrolytic manganese dioxide is particularly preferable because it is easily available.

Examples of the fluorinated carbon include fluorinated graphite represented by (CF_{w})ₘ, where m is an integer of 1 or more, and 0<w≦1. Examples of the sulfide include: metal sulfides, such as TiS₂, MoS₂, and FeS₂; and organic sulfur compounds. Examples of the lithium-containing composite oxide include LiₓₐCoO₂, LiₓₐNiO₂, LiₓₐMnO₂, LiₓₐCo_{y}Ni_{1-y}O₂, LiₓₐCo_{y}M_{1-y}O_{z}, LiₓₐNi_{1-y}M_{y}O_{z}, Li_{xb}Mn₂O₄, and Li_{xb}Mn_{2-y}M_{y}O₄. In each formula, M is at least one element selected from the group consisting of Na, Mg, Sc, Y, Mn, Fe, Co, Ni, Cu, Zn, Al, Cr, Pb, Sb and B; and xa=0 to 1.2, xb=0 to 2, y=0 to 0.9, and z=2 to 2.3. Here, xa and xb are the values before the start of charge and discharge, and vary during charge and discharge.

The positive electrode active material preferably has a volumetric average particle size (D50) of 0.1 to 10 μm. In the case where such a positive electrode active material is used, in the process of applying a positive electrode material mixture paste onto the positive electrode current collector to form a thin material mixture layer having a thickness of 50 μm or less, uneven application is unlikely to occur. As a result, the variations in electrode capacity per unit area which are due to occurrence of uneven application can be reduced, and a homogeneous positive electrode active material layer is readily obtained.

Examples of the conductive agent include: graphites, such as natural graphite and artificial graphite; carbon blacks, such as acetylene black, Ketjen black, channel black, furnace black, lamp black, and thermal black; conductive fibers, such as carbon fibers and metal fibers; metal powders, such as aluminum powder; conductive whiskers, such as zinc oxide whisker and potassium titanate whisker; conductive metal oxides, such as titanium oxide; and organic conductive materials, such as phenylene derivatives. These may be used singly or in combination of two or more. The content of the conductive agent in the positive electrode active material layer is preferably 1 to 30 parts by weight per 100 parts by weight of the positive electrode active material, in view of improving the conductivity of the positive electrode active material layer and ensuring the capacity of the positive electrode.

Examples of the binder include polyvinylidene fluoride (PVDF), polytetrafluoroethylene, polyethylene, polypropylene, aramid resin, polyamide, polyimide, polyamide-imide, polyacrylonitrile, polyacrylic acid, polymethyl acrylate, polyethyl acrylate, polyhexyl acrylate, poly methacrylic acid, polymethyl methacrylate, polyethyl methacrylate, polyhexyl methacrylate, polyvinyl acetate, polyvinylpyrrolidone, polyether, polyether sulfone, hexafluoropolypropylene, styrene-butadiene rubber, and carboxymethyl cellulose. These may be used singly or in combination of two or more. The content of the binder in the positive electrode active material layer is preferably 1 to 15 parts by weight per 100 parts by weight of the positive electrode active material, in view of improving the bonding property in the positive electrode active material layer and ensuring the capacity of the positive electrode.

Another example of the binder is a polymer electrolyte. By using a polymer electrolyte, lithium ions are smoothly diffused throughout the positive electrode active material layer, which facilitates the electron transfer between the positive electrode current collector and the positive electrode active material layer. The polymer electrolyte may be used singly as the binder, or used in combination with another binder.

The polymer electrolyte includes a matrix polymer and a lithium salt. The matrix polymer preferably has a polymer chain including an element with electron-donating property. The structure of the matrix polymer may be linear or branched. The matrix polymer is composed of, for example, one kind of monomer including an electron donor element, or a copolymer being a combination of two or more kinds of monomers. In the case of a copolymer, at least one of the monomers includes an electron donor element. The copolymer may be a graft copolymer or a block copolymer, or may include a cross-linking structure. In the case where the matrix polymer has a principal chain and a side chain, like a graft copolymer, at least one of the principal chain and the side chain may include an electron donor element.

Examples of the electron donor element include ether oxygen (oxygen in an ether group) and ester oxygen (oxygen in an ester group). The matrix polymer including such an element may be, for example, polyethylene oxide, polypropylene oxide, a copolymer of ethylene oxide and propylene oxide, a polymer having ethylene oxide units, a polymer having propylene oxide units, or polycarbonate. Another example of the electron donor element other than oxygen is nitrogen. The matrix polymer containing nitrogen may be, for example, a polyimide-based polymer or a polyacrylonitrile-based polymer. These may be used singly or in combination of two or more. The molecular weight of the matrix polymer is, for example, 1,000 to 10,000,000. A preferable matrix polymer is polyethylene oxide. The molecular weight of the polyethylene oxide is preferably 1,000 to 10,000,000.

Since the matrix polymer includes an electron donor element as described above, dissociation of lithium salt occurs. The lithium salt is dissolved in the matrix polymer, in such a state that at least part thereof is dissociated into lithium ions and anions. Examples of the lithium salt include LiClO₄, LiBF₄, LiPF₆, LiAlCl₄, LiSbF₆, LiSCN, LiCF₃SO₃, LiAsF₆, lithium lower aliphatic carboxylate, LiCl, LiBr, LiI, chloroborane lithium, lithium tetraphenylborate, and imides such as LiN(CF₃SO₂)₂ and LiN(C₂F₅SO₂)₂. These may be used singly or in combination of two or more. Among these, LiClO₄ and imides are preferable because the degree of dissociation thereof in the matrix polymer is high, and a high electrical conductivity can be obtained. The concentration of the lithium salt in the matrix polymer is preferably 0.005 to 0.125 mol/L.

The electrode current collector may be an electrolytic metal foil obtained by electrolytic process or a rolled metal foil obtained by rolling. Electrolytic process is advantageous in that it is excellent in mass productivity and comparatively low in production cost. On the other hand, rolling, by which the thickness can be easily reduced, is advantageous for reducing the weight. The rolled metal foil, in which crystals are oriented along the rolling direction, is excellent in bending resistance, and is suitable for a thin flexible battery.

The electrolytic metal foil is obtained by, for example, immersing a drum as an electrode in an electrolytic bath including ions of a predetermined metal, and passing current through the drum while the drum is rotated. The predetermined metal is deposited on the surface of the drum. By peeling the deposited matter, a metal foil is obtained. In the electrolytic metal foil, one surface thereof having faced the drum is referred to as a “gloss surface”, and the other surface thereof having faced the electrolytic bath is referred to as a “mat surface”. The mat surface is rougher than the gloss surface. It is preferable, for example, to use the gloss surface as it is or after subjected to smoothing treatment, as the outside surface being in contact with the resin layer at the inner side of the housing, and use the mat surface as it is or after subjected to roughening treatment, as the inside surface being in contact with the active material layer. The smoothing treatment and the roughening treatment may be applied to either one of the gloss surface and the mat surface, or if necessary, may be applied to both of them.

The surface roughness of the electrode current collector can be controlled by smoothing and/or roughening the surface of the electrode current collector, as described above. The surface of the electrode current collector may be smoothed by, for example, bright plating, electrolytic polishing, or rolling. The surface of the electrode current collector may be roughened by, for example, blasting. In blasting, the surface roughness of the electrode current collector can be easily controlled by changing the ejection pressure, ejection distance, and blasting time. Alternatively, metal may be deposited on the surface of the rolled metal foil by electrolytic process. For example, metal may be deposited on the electrode current collector in an acidic electrolytic bath at a high current density close to the limiting current density, thereby to roughen the surface of the electrode current collector. In addition to the above surface treatment, the electrode current collector may be further subjected to chromate treatment, in order to improve its corrosion resistance.

The electrolyte layer comprises, for example, a separator impregnated with a non-aqueous electrolyte, or a layer of the polymer electrolyte as described above. The separator may be, for example, a porous sheet being applicable to a thin flexible battery and having predetermined ion permeability, mechanical strength, and insulating property. The porous sheet encompasses, for example, a woven fabric, a non-woven fabric, and a microporous film.

The separator is preferably a microporous film including polyolefin such as polypropylene, polyethylene, polyethylene terephthalate, or polyphenylene sulfide, in view of the resistance to electrolyte, the shutdown function, and the battery safety. The separator may be a single-layer film or a multi-layer film (a composite film).

The thickness of the separator is, for example, 8 to 40 μm, and preferably 8 to 30 μm. The porosity of the separator is preferably 30 to 70%, and more preferably 35 to 60%. The “porosity” as used herein is a ratio of the total volume of the pores in the separator to the apparent volume of the separator.

The non-aqueous electrolyte includes a non-aqueous solvent and a supporting salt dissolved in the non-aqueous solvent, and may further include, as needed, various additives.

Examples of the supporting salt include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, LiBCl₄, borates, the abovementioned imides. These may be used singly or in combination of two or more. The concentration of the supporting salt in the non-aqueous solvent is preferably 0.5 to 2 mol/L.

Examples of the non-aqueous solvent include cyclic carbonic acid esters, chain carbonic acid esters, cyclic carboxylic acid esters, cyclic ethers, and chain ethers. Cyclic carbonic acid esters are exemplified by ethylene carbonate and propylene carbonate. Chain carbonic acid esters are exemplified by dimethyl carbonate, ethyl methyl carbonate, and diethyl carbonate. Cyclic carboxylic acid esters are exemplified by y-butyrolactone. Cyclic ethers are exemplified by tetrahydrofuran and 2-methyltetrahydrofuran. Chain ethers are exemplified by dimethoxyethane and dimethoxymethane. These may be used singly or in combination of two or more.

An additive may be added to the non-aqueous electrolyte for the purpose of, for example, improving the charge/discharge efficiency. Specifically, the additive is preferably at least one selected from the group consisting of vinylene carbonate, vinyl ethylene carbonate, and divinylethylene carbonate. In the above compounds, some of the hydrogen atoms may be substituted by fluorine atoms.

The barrier layer included in the housing 8 is preferably of an aluminum foil, a nickel foil, or a stainless steel foil, in view of the strength and the bending resistance. The thickness of the barrier layer is preferably 10 to 50 μm, in view of the strength and the flexibility. The thickness of the resin layer formed on both surfaces of the barrier layer is preferably 10 to 100 μm.

The resin layer at the inner side of the housing is preferably of polyolefin such as polyethylene (PE) or polypropylene (PP), polyethylene terephthalate (PET), polyamide, polyurethane, or polyethylene-vinyl acetate copolymer, in view of the strength, impact resistance and electrolyte resistance. The surface roughness of the resin layer at the inner side of the housing is generally 0.01 to 1 μm.

The resin layer at the outer side of the housing is preferably of polyamide (PA) such as 6,6-nylon, polyolefin such as polyethylene (PE) or polypropylene (PP), or PET, in view of the strength, impact resistance and chemical resistance.

Specifically, the housing 8 may be, for example, of: a laminated film of PP, Al foil and nylon, a laminated film of PP, Al foil and PP; a laminated film of PE, Al foil and PE; a laminated film of acid-modified PP, PET, Al foil and PET; a laminated film of acid-modified PE, PA, Al foil and PET; a laminated film of ionomer resin, Ni foil, PE and PET; a laminated film of ethylene-vinyl acetate copolymer, PE, Al foil and PET; a laminated film of ionomer resin, PET, Al foil and PET. The resin layer at the inner side of these laminated films is preferably a resin layer which is weldable at a comparatively low temperature, for example, a layer of polyolefin such as polyethylene (PE) or polypropylene (PP), ionomer resin, or of ethylene-vinyl acetate copolymer.

The thin flexible battery of the present invention is fabricated, for example, in the following manner. The negative electrode and the positive electrode are arranged such that the negative electrode active material layer and the positive electrode active material layer face each other, and laminated with a separator interposed therebetween, to form an electrode group. At this time, a negative electrode lead is attached to the negative electrode, and a positive electrode lead is attached to the positive electrode. A belt-like laminated film is folded in double, with both ends thereof being aligned, and the ends are welded to each other, to form a tubular film. The electrode group is inserted into the tubular film from one opening thereof, and the opening is closed by thermal welding. At this time, the electrode group is positioned such that the positive and negative electrode leads are partially exposed outside the tubular film through the opening of the tubular film. The exposed portions serve as positive and negative electrode terminals. Subsequently, a non-aqueous electrolyte is injected into the tubular film through the other opening thereof, and the opening is closed by thermal welding. The electrode group is thus hermetically enclosed in the film.

Next, one example of electronic equipment provided with the thin flexible battery of the present invention is described.

Recently, in the medical field, for the purpose of monitoring the biological information of, for example, patients by, for example, doctors, development is being made for wearable portable digital assistants (PDAs) which are always directly attached to the body and regularly measure the biological information, such as the blood pressure, body temperature, and pulse, to wirelessly transmit the measured information. Since such wearable PDAs are used in close contact with the body, they are required to have a certain degree of flexibility that does not make the user feel uncomfortable even when used in close contact for a long period of time. Accordingly, driving power sources for wearable PDAs are also required to have excellent flexibility. The thin flexible battery of the present invention is useful as a power source for such wearable PDAs.

FIG. 4A is an oblique view showing one example of a biological information measuring device being a wearable PDA. FIG. 4B shows one example of the appearance of the device in a deformed state.

A biological information measuring device 40 is formed by stacking a holding member 41 for electronic devices and a thin flexible battery 42. The holding member 41 is formed of a sheet-like material with flexibility, and includes a temperature sensor 43, a pressure sensitive element 45, a memory 46, an information transmitter 47, a button switch SW1, and a controller 48, which are embedded inside thereof under the surface. The battery 42 is mounted in a flat space provided inside the holding member 41.

For the holding member 41, for example, an electrically insulating resin material with flexibility may be used. For example, an adhesive 49 with adhesion strength may be applied onto one principle surface of the biological information measuring device 40, whereby the biological information measuring device 40 can be attached around, for example, the wrist, ankle, or neck of the user.

The temperature sensor 43 is formed of, for example, a heat sensitive element, such as a thermistor or a thermocouple, and outputs signals indicating the body temperature of the user to the controller 48. The pressure sensitive element 45 outputs a signal indicating the blood pressure and pulse of the user to the controller 48. The memory 46 for storing information corresponding to the outputted signals may be formed of, for example, a nonvolatile memory. The information transmitter 47 converts necessary information into radio waves, according to the signals from the controller 48, and radiates the radio waves. The switch SW1 is used for turning on or off the biological information measuring device 40. The temperature sensor 43, the pressure sensitive element 45, the memory 46, the information transmitter 47, the switch SW1, and the controller 48 are mounted on, for example, a flexible circuit board, and electrically connected to one another through a wiring pattern formed on the surface of the circuit board.

The controller 48 includes, for example, a CPU (Central Processing Unit) for performing a predetermined computation, a RAM (Random Access Memory) storing the controlling program of the device, a ROM (Read Only Memory) for temporarily storing data, and peripheral circuits, and runs the program stored in the ROM, thereby to control the operation of each component of the biological information measuring device 40.

The present invention is specifically described below with reference to Examples. It should be noted, however, the present invention is not limited to these Examples.

### EXAMPLE 1

A thin flexible battery as shown FIG. 1 was fabricated in the following manner.

### (1) Production of Negative Electrode Current Collector

Electrolysis was performed under the following conditions, to provide an electrolytic copper foil having a thickness of 12 μm.

Electrolytic bath: Copper sulfate solution (concentration of copper: 100 g/L, concentration of sulfuric acid: 100 g/L)

Anode: Titanium with noble metal oxide coating

Cathode: Titanium rotation drum

Current density: 50 A/dm²

Bath temperature: 50° C.

The mat surface of the electrolytic copper foil had a surface roughness of 0.5 μm, and the gloss surface thereof had a surface roughness of 0.1 μm. The surface roughness Rz was measured using a surface roughness meter (Model SE-3C, available from Kosaka Laboratory Ltd.).

Bright plating was applied to both surfaces of the electrolytic copper foil under the following conditions.

Composition of plating bath: Metal copper 55 g/L, sulfuric acid 55 g/L, chloride ions 90 ppm, and an additive, a bright copper plating additive for decoration (Cupracid 210, available from Nihon Schering K. K.)

Counter electrode: Phosphorus-containing copper plate

Bath temperature: 27° C.

Current density: 6 A/dm²

The mat surface of the electrolytic copper foil with bright plating had a surface roughness of 0.3 μm, and the gloss surface thereof had a surface roughness of 0.05 μm.

Blasting was applied to both surfaces of the electrolytic copper foil with bright plating, by using a suction-type air blasting apparatus (a suction-type blasting machine Model B-0, with nozzle diameter of 9 mm, available from Atsuchi Tekko Co., Ltd.), under the following conditions. The ejection pressure was changed within the range shown below, to adjust the surface roughness of both surfaces of the copper foil as shown in Table 1. Blasting was followed by air-blowing.

Blasting particles: Alundum particles with average particle size of 3 μm

Ejection pressure: 0.1 to 0.9 MPa

Ejection distance: 100 mm

Blasting time: 30 sec

### (2) Production of Negative Electrode

The electrolytic copper foil obtained in the above was heated at 120° C. for 2 hours in an argon atmosphere, to give a negative electrode current collector 1. The elongation percentage of the electrolytic copper foil after heat treatment was 7.1%. The elongation percentage was determined by using a test piece (12.5 mm×30 mm) and performing a tensile test in accordance with the above-described method using a universal tester (Model 4505) available from Instron Corporation.

A lithium metal foil (thickness: 20 μm) serving as a negative electrode active material layer 2 was press-fitted onto one surface of the electrolytic copper foil serving as the negative electrode current collector 1 at a line pressure of 100 N/cm, to give a negative electrode 11. The resultant negative electrode was cut in a size of 30 mm×30 mm with a 5 mm×5 mm tab, and a negative electrode lead 3 made of copper was ultrasonically welded to the tab.

### (3) Production of Positive Electrode

Electrolytic manganese dioxide having been heated at 350° C. serving as a positive electrode active material, acetylene black serving as a conductive agent, an N-methyl-2-pyrrolidone (NMP) solution containing polyvinylidene fluoride (PVDF) serving as a binder (#8500 available from Kureha Corporation) were mixed such that the weight ratio of manganese dioxide:acetylene black:PVDF=100:5:5, to which an appropriate amount of NMP was added, to give a positive electrode material mixture paste.

The positive electrode material mixture was applied onto one surface of an aluminum foil (thickness: 15 μm, surface roughness Rz of both surfaces: 2.1 μm) serving as a positive electrode current collector 4, and dried at 85° C. for 10 minutes, to form a positive electrode active material layer 5, which was then subjected to compression at a line pressure of 12,000 N/cm by using a roll pressing machine, thereby to give a positive electrode 12.

The positive electrode 12 was cut in a size of 30 mm×30 mm with a 5 mm×5 mm tab, and was dried under reduced pressure at 120° C. for 2 hours. A positive electrode lead 6 made of aluminum was ultrasonically welded to the tab.

### (4) Production of Electrode Group

The negative electrode 11 and the positive electrode 12 were arranged such that the negative electrode active material layer 2 and the positive electrode active material layer 5 faced each other, and a separator being a microporous polyethylene film (thickness: 9 μm, width: 32 mm) was interposed between the negative electrode 11 and the positive electrode 12, whereby an electrode group 13 was formed.

### (5) Assembling of Battery

The electrode group 13 was inserted in a housing 8 made of a tubular aluminum laminated film.

The aluminum laminated film used here was a laminated film of PP, aluminum and nylon (PA), D-EL40H (thickness: 110 μm) available from Dai Nippon Printing Co., Ltd. The surface roughness of the inner side (PP) of the aluminum laminated film was 0.27 μm.

The positive electrode lead 6 and the negative electrode lead 3 were passed through one opening of the housing 8, to allow part of the positive electrode lead 6 and part of the negative electrode lead 3 to be exposed outside the housing 8. The one opening of the housing 8 was closed with the leads being sandwiched therebetween, by thermal welding. The portion exposed outside the housing 8 of the positive electrode lead 6 and that of the negative electrode lead 3 were used as a positive electrode terminal and a negative electrode terminal, respectively.

Next, 0.8 g of non-aqueous electrolyte was injected into the housing 8 through the other opening thereof, and then, air was evacuated therefrom for 10 seconds in a reduced pressure atmosphere of −750 mmHg. The non-aqueous electrolyte had been prepared by dissolving LiClO₄ at a concentration of 1 mol/L in a non-aqueous solvent. For the non-aqueous solvent, a mixed solvent of propylene carbonate and dimethoxyethane (volume ratio 1:1) was used.

The abovementioned other opening of the housing 8 was closed by thermal welding, to hermetically enclose the electrode group 13 in the housing 8. A thin flexible battery (45 mm×45 mm) having a thickness of 400 μm was thus fabricated. The battery was aged at 45° C. for 1 day.

### [Evaluation]

### (1) Bending Test

Two batteries as fabricated above were prepared.

With respect to one of the batteries, the internal resistance was measured, and a discharge test was performed under the following conditions to determine a discharge capacity A before bending test.

Ambient temperature: 25° C.

Current density of discharge: 250 μA/cm² (current value per unit area of the positive electrode)

Cut-off voltage of discharge: 1.8 V

The other battery, a battery 21, was fixed as shown in FIG. 5, such that the both ends thereof having been thermally welded were held with stretchable fixing members 32a and 32b that are arranged horizontally to face each other. A jig 31 having a curved face 31a having a curvature radius R of 20 mm was pushed against the side facing the negative electrode of the battery 21, to deform the battery 21 along the curved face 31a. Thereafter, the jig 31 was pulled apart from the battery 21, to allow the original shape to be restored. This process (about 30 seconds per one push and pull) was repeated 10,000 times in total. With respect to the resultant battery, the internal resistance was measured, and a discharge test was performed under the same conditions as above to determine a discharge capacity B after bending test.

A capacity retention rate after bending test (%) was calculated from the equation below:

Capacity retention rate after bending test (%)=(Discharge capacity B after bending test/Discharge capacity A before bending test)×100.

### (2) Inspection of Disassembled Battery

The presence or absence of wrinkles on the housing at the side facing the negative electrode was checked. The battery in which no wrinkles were detected on the housing was indicated as “∘”, and the battery in which wrinkles were detected on the housing was indicated as “×”.

After the presence or absence of wrinkles was checked, the battery was disassembled. The condition around the negative electrode current collector (the negative electrode current collector, and the negative electrode lead serving as a negative electrode terminal) was checked. The condition where no damage was detected at all on the negative electrode current collector and the negative electrode lead was ranked as “A”. The condition where a partial defect was detected on the negative electrode current collector and the negative electrode lead, but the electrical connection therebetween was not damaged at all was ranked as “B”. The condition where critical damage resulting in a complete cut was detected on at least one point on the negative electrode current collector and the negative electrode lead (in this case, the electrical connection at the cut point is achieved by contact) was ranked as “C”.

The above evaluation results are shown in Tables 1A, 1B and 1C. In Tables 1A, 1B and 1C, batteries No. 1 to 7, 11 and 12 are of Example, and batteries No. 8 to 10 and 13 are of Comparative Example.

TABLE 1A

| | Conditions | | Negative electrode | | |
|---|---|---|---|---|---|
| | of blasting | | current collector | | |
| | | Ejection | Surface | Surface | |
| | Ejection | pressure on | roughness | roughness | |
| | pressure on | gloss | Rz1 of gloss | Rz2 of mat | Bending test |
| Battery | mat surface | surface | surface | surface | Wrinkles on |
| No. | (MPa) | (MPa) | (μm) | (μm) | housing |
| 1 | 0.2 | Not blasted | 0.05 | 0.4 | ◯ |
| 2 | 0.2 | 0.1 | 0.3 | 0.4 | ◯ |
| 3 | 0.3 | 0.05 | 0.2 | 5 | ◯ |
| 4 | 0.4 | Not blasted | 0.05 | 10 | ◯ |
| 5 | 0.4 | 0.1 | 0.3 | 10 | ◯ |
| 6 | Not blasted | Not blasted | 0.05 | 0.3 | ◯ |
| 7 | Not blasted | 0.1 | 0.3 | 0.3 | ◯ |
| 8 (Com.) | Not blasted | 0.2 | 0.4 | 0.3 | X |
| 9 (Com.) | 0.2 | 0.2 | 0.4 | 0.4 | X |
| 10 (Com.) | 0.4 | 0.2 | 0.4 | 10 | X |
| 11 | 0.6 | Not blasted | 0.05 | 20 | ◯ |
| 12 | 0.6 | 0.1 | 0.3 | 20 | ◯ |
| 13 (Com.) | 0.6 | 0.2 | 0.4 | 20 | X |

As shown in Table 1A, when Rz1 was 0.05 to 0.3 μm, no wrinkles occurred on the housing. This is presumably because the surface of the negative electrode current collector, the surface being in contact with the resin layer at the inner side of the housing, was smooth, and the slippage between the negative electrode current collector and the housing was improved.

TABLE 1B

| | | | Negative electrode | | |
|---|---|---|---|---|---|
| | Conditions of blasting | | current collector | | Bending test |
| | | Ejection | Surface | Surface | Condition around |
| | Ejection | pressure on | roughness | roughness | negative |
| | pressure on | gloss | Rz1 of gloss | Rz2 of mat | electrode |
| Battery | mat surface | surface | surface | surface | current |
| No. | (MPa) | (MPa) | (μm) | (μm) | collector |
| 1 | 0.2 | Not blasted | 0.05 | 0.4 | A |
| 2 | 0.2 | 0.1 | 0.3 | 0.4 | A |
| 3 | 0.3 | 0.05 | 0.2 | 5 | A |
| 4 | 0.4 | Not blasted | 0.05 | 10 | A |
| 5 | 0.4 | 0.1 | 0.3 | 10 | A |
| 6 | Not blasted | Not blasted | 0.05 | 0.3 | A |
| 7 | Not blasted | 0.1 | 0.3 | 0.3 | A |
| 8 (Com.) | Not blasted | 0.2 | 0.4 | 0.3 | C |
| 9 (Com.) | 0.2 | 0.2 | 0.4 | 0.4 | C |
| 10 (Com.) | 0.4 | 0.2 | 0.4 | 10 | C |
| 11 | 0.6 | Not blasted | 0.05 | 20 | B |
| 12 | 0.6 | 0.1 | 0.3 | 20 | B |
| 13 (Com.) | 0.6 | 0.2 | 0.4 | 20 | C |

Among Examples, when the surface roughness Rz2 of the inside surface of the negative electrode current collector, the surface being in contact with the negative electrode active material layer, was 10 μm or less, the condition around the negative electrode current collector was good after the bending test. On the other hand, when Rz2 exceeded 10 μm, a partial defect was detected (Rank B). This is presumably because stress was locally generated in the negative electrode current collector. It should be noted that even in the case of Rank B, electrical connection was good.

TABLE 1C

| | | | Negative electrode | | | | |
|---|---|---|---|---|---|---|---|
| | Conditions of blasting | | current collector | | Bending test | | |
| | Ejection pressure | Ejection pressure | Surface roughness | Surface roughness | Internal resistance | Internal resistance | Capacity |
| Battery | on mat surface | on gloss surface | Rz1 of gloss | Rz2 of mat | before bending | after bending | retention |
| No. | (MPa) | (MPa) | surface (μm) | surface (μm) | test (Ω) | test (Ω) | rate (%) |
| 1 | 0.2 | Not blasted | 0.05 | 0.4 | 1.1 | 1.3 | 97.6 |
| 2 | 0.2 | 0.1 | 0.3 | 0.4 | 1.2 | 1.4 | 97.5 |
| 3 | 0.3 | 0.05 | 0.2 | 5 | 1.2 | 1.2 | 98.2 |
| 4 | 0.4 | Not blasted | 0.05 | 10 | 1.1 | 1.1 | 98.1 |
| 5 | 0.4 | 0.1 | 0.3 | 10 | 1.0 | 1.0 | 98.2 |
| 6 | Not blasted | Not blasted | 0.05 | 0.3 | 1.2 | 2.1 | 87.4 |
| 7 | Not blasted | 0.1 | 0.3 | 0.3 | 1.3 | 2.2 | 88.1 |
| 8 (Com.) | Not blasted | 0.2 | 0.4 | 0.3 | 1.2 | 6.9 | 54.2 |

when the surface roughness Rz2 of the inside surface of the negative electrode current collector, the surface being in contact with the negative electrode active material layer, was 0.4 to 10 μm, the internal resistance of the battery after bending test was low, and a high battery capacity was obtained. This is presumably because the adhesion between the negative electrode current collector and the negative electrode active material layer was improved by the anchoring effect. On the other hand, when Rz2 was below 0.4 μm, the internal resistance of the battery after bending test tended to increase, and the battery capacity decreased. This is presumably because the anchoring effect between the negative electrode current collector and the negative electrode active material layer was reduced, and the adhesion therebetween was lowered as they were repeatedly bent. However, the capacity retention rates of the batteries of Example were still high as compared to that of Comparative Example (No. 8).

Next, the material of the negative electrode current collector was evaluated.

### EXAMPLE 2

Rolled metal foils having a thickness of 20 μm were surface-treated, so that the inside surfaces thereof had a surface roughness Rz2 of 5 μm, and the outside surfaces thereof had a surface roughness Rz1 of 0.2 μm. The metal materials shown in Table 2 were used for these rolled metal foils. Batteries were fabricated in the same manner as battery No. 3 of Example 1, except the above, and subjected to the bending test. The evaluation results are shown in Table 2.

TABLE 2

| | Negative electrode current collector | | | | | Bending test | | | | |
|---|---|---|---|---|---|---|---|---|---|---|
| | | | Surface | Surface | | Internal | Internal | | | |
| | | | roughness | roughness | Elongation | resistance | resistance | Capacity | Condition around | Wrinkles |
| Battery | | | Rz1 of gloss | Rz2 of mat | percentage | before bending | after bending | retention | negative electrode | on |
| No. | Type | Material | surface (μm) | surface (μm) | (%) | test (Ω) | test (Ω) | rate (%) | current collector | housing |
| 3 | Electro- | Copper | 0.2 | 5 | 7.1 | 1.2 | 1.2 | 98.2 | A | ◯ |
| | lytic foil | | | | | | | | | |
| 21 | Rolled foil | Copper | 0.2 | 5 | 5.9 | 1.1 | 1.1 | 98.1 | A | ◯ |
| 22 | Rolled foil | Nickel | 0.2 | 5 | 5.6 | 1.3 | 1.3 | 98.2 | A | ◯ |
| 23 | Rolled foil | Titanium | 0.2 | 5 | 5.5 | 1.5 | 1.5 | 98.1 | A | ◯ |
| 24 | Rolled foil | Stainless | 0.2 | 5 | 5.5 | 1.9 | 1.9 | 98.1 | A | ◯ |
| | | steel | | | | | | | | |

As shown in Table 2, all the batteries exhibited excellent bending resistance.

In the case where the material of the negative electrode current collector was changed to nickel, titanium or stainless steel, as in the case where the material of the negative electrode current collector was copper, the internal resistance of the battery after bending test was low, and a high battery capacity was obtained. Particularly, in the case of using copper, which is excellent in electrical conductivity, the internal resistance of the battery was low. Copper is advantageous also in that it is excellent in processability.

Next, the thickness of the negative electrode current collector and the heating atmosphere of the negative electrode current collector were evaluated.

### EXAMPLE 3

Batteries were fabricated in the same manner as in Example 1, except that the thickness of the negative electrode current collector and the heating atmosphere of the negative electrode current collector were changed as shown in Table 3. Here, the thickness of the negative electrode current collector was adjusted by changing the rotation speed of the drum in producing the electrolytic copper foil.

Batteries were fabricated in the same manner as battery No. 3 of Example 1, except the above, and subjected to the bending test. The evaluation results are shown in Table 3.

TABLE 3

| | Negative electrode | | | | | | | |
|---|---|---|---|---|---|---|---|---|
| | current collector | | | Bending test | | | | |
| | | Heating | | Internal resistance | Internal resistance | Capacity | Condition around | Wrinkles |
| Battery | Heating | temperature | Thickness | before bending | after bending | retention rate | negative electrode | on |
| No. | atmosphere | (° C.) | (μm) | test (Ω) | test (Ω) | (%) | current collector | housing |
| 31 | Argon | 120 | 3 | 1.3 | 1.8 | 89.1 | A | ◯ |
| 32 | Argon | 120 | 5 | 1.3 | 1.6 | 97.9 | A | ◯ |
| 3 | Argon | 120 | 20 | 1.2 | 1.2 | 98.2 | A | ◯ |
| 33 | Argon | 120 | 30 | 1.3 | 1.8 | 96.8 | A | ◯ |
| 34 | Argon | 120 | 40 | 1.3 | 1.9 | 88.3 | A | ◯ |
| 35 | Vacuum | 120 | 20 | 1.2 | 1.4 | 97.5 | A | ◯ |
| 36 | Nitrogen | 120 | 20 | 1.2 | 1.2 | 98.2 | A | ◯ |

As shown in Table 3, all the batteries exhibited excellent bending resistance. When the thickness of the negative electrode current collector was 5 to 30 μm, the internal resistance of the battery after bending test was particularly low, and a high battery capacity was obtained.

When the thickness of the negative electrode current collector exceeded 30 μm, the internal resistance of the battery after bending test was increased by some extent. This is presumably because the flexibility of the negative electrode current collector was lowered, and stress was generated in the negative electrode current collector during bending, causing the adhesion between the negative electrode active material layer and the negative electrode current collector to be lowered. When the thickness of the negative electrode current collector was below 5 μm, the internal resistance of the battery after bending test was increased by some extent, and the battery capacity was reduced. This is presumably because the strength of the negative electrode current collector was reduced, and damage undetectable by visual inspection was caused in the negative electrode current collector during bending.

With regard to the heating atmosphere, the results show that in the case of heating in a non-oxidizing atmosphere such as a nitrogen atmosphere or in a vacuum, as in the case of heating in an argon atmosphere, the surface oxidation of the negative electrode current collector can be prevented, and favorable electrode characteristics can be obtained.

Next, the heating temperature of the negative electrode current collector was evaluated.

### EXAMPLE 4

Batteries were fabricated in the same manner as in Example 1, except that the heating temperature of the negative electrode current collector was changed as shown in Table 4, and subjected to the bending test. The evaluation results are shown in Table 4.

TABLE 4

| | Negative electrode current collector | | | | Bending test | | | | |
|---|---|---|---|---|---|---|---|---|---|
| | | Heating | | Elongation | Internal resistance | Internal resistance | Capacity | Condition around | Wrinkles |
| Battery | Heating | temperature | Thickness | percentage | before bending | after bending | retention | negative electrode | on |
| No. | atmosphere | (° C.) | (μm) | (%) | test (Ω) | test (Ω) | rate (%) | current collector | housing |
| 41 | Argon | 60 | 20 | 3 | 1.2 | 1.8 | 88.2 | A | ◯ |
| 42 | Argon | 80 | 20 | 5 | 1.2 | 1.3 | 95.5 | A | ◯ |
| 3 | Argon | 120 | 20 | 7.1 | 1.2 | 1.2 | 98.2 | A | ◯ |
| 43 | Argon | 200 | 20 | 10 | 1.2 | 1.2 | 96.7 | A | ◯ |
| 44 | Argon | 400 | 20 | 15 | 1.2 | 1.2 | 94.1 | A | ◯ |
| 45 | Argon | 500 | 20 | 24 | 1.2 | 1.9 | 88.1 | A | ◯ |

As shown in Table 4, all the batteries exhibited excellent bending resistance. When the heating temperature was 80 to 400° C., the elongation percentage of the negative electrode current collector was 5 to 15%. In the case where the elongation percentage of the negative electrode current collector was 5 to 15%, the internal resistance of the battery after bending test was low, and a high battery capacity was obtained. It is considered that when the elongation percentage of the negative electrode current collector was 5 to 15%, the followability of the negative electrode current collector to the deformation of the negative electrode during bending of the battery was significantly improved.

When the elongation percentage of the negative electrode current collector was below 5%, the internal resistance of the battery after bending test was increased by some extent, and the battery capacity was reduced. This is presumably because damage undetectable by visual inspection was caused in the negative electrode current collector during bending of the battery. When the elongation percentage of the negative electrode current collector exceeded 15%, the internal resistance of the battery after bending test was increased by some extent, and the battery capacity was reduced. This is presumably because the mechanical strength of the negative electrode current collector was lowered by some extent due to the increase in elongation percentage of the negative electrode current collector, and damage undetectable by visual inspection was caused in the negative electrode current collector.

Next, the thickness of the negative electrode active material layer and the capacity of the negative electrode were evaluated.

### EXAMPLE 5

Batteries were fabricated in the same manner as battery No. 3 in Example 1, except that the thickness of the negative electrode active material layer (i.e., the lithium metal foil) to be press-fitted to the negative electrode current collector was changed as shown in Table 5, and subjected to the bending test. The evaluation results are shown in Table 5.

TABLE 5

| | Negative electrode | | | | | | | |
|---|---|---|---|---|---|---|---|---|
| | active material layer | | Bending test | | | | | |
| | | Capacity of negative | Internal resistance | Internal resistance | Capacity | Discharge capacity | Condition around | Wrinkles |
| Battery | Thickness | electrode | before bending | after bending | retention | after bending | negative electrode | on |
| No. | (μm) | (mAh/cm²) | test (Ω) | test (Ω) | rate (%) | test (mAh) | current collector | housing |
| 51 | 5 | 0.5 | 1.2 | 1.6 | 89.1 | 7.5 | A | ◯ |
| 52 | 10 | 1.0 | 1.2 | 1.2 | 97.4 | 16.4 | A | ◯ |
| 3 | 20 | 2.0 | 1.2 | 1.2 | 98.2 | 32.9 | A | ◯ |
| 53 | 100 | 10 | 1.2 | 1.4 | 97.5 | 163.7 | A | ◯ |
| 54 | 120 | 12 | 1.2 | 1.8 | 88.4 | 177.7 | A | ◯ |

As shown in Table 5, all the batteries exhibited excellent bending resistance. When the thickness of the negative electrode active material layer was 5 to 120 μm, the capacity of the negative electrode was 0.5 to 12 mAh/cm². When the thickness of the negative electrode active material layer was 10 to 100 μm, that is, the capacity per unit area of the negative electrode was 1 to 10 mAh/cm², the internal resistance of the battery after bending test was low, and a high battery capacity was obtained.

When the thickness of the negative electrode active material layer exceeded 100 μm, the internal resistance of the battery after bending test was increased by some extent, and the battery capacity was reduced. This is presumably because the flexibility of the negative electrode active material layer was lowered by some extent due to an increased thickness of the negative electrode active material layer, and part of the lithium foil separated from the negative electrode current collector. When the thickness of the negative electrode active material layer was below 10 μm, the capacity of the negative electrode was reduced, which resulted in a small theoretical capacity of the battery. Here, the thickness of the negative electrode active material layer is a thickness thereof in an undischarged state.

### EXAMPLE 6

Batteries were fabricated in the same manner as battery No. 3 or 9 in Example 1, except that the surface roughness of both surfaces of the aluminum foil serving as the positive electrode current collector was changed to 0.4 μm, 0.3 μm, 0.2 μm or 0.05 μm, and subjected to the bending test in which the jig 31 was pushed against the side facing the positive electrode of the battery 21, to deform the battery 21.

The presence or absence of wrinkles on the housing at both sides facing the positive electrode and the negative electrode was checked. The battery in which no wrinkles were detected on the housing at both sides facing the positive electrode and the negative electrode was indicated as “∘”, and the battery in which wrinkles were detected on the housing at at least one of the sides facing the positive electrode and the negative electrode was indicated as “×”. Further, the battery in which wrinkles had occurred on the housing at at least one of the sides facing the positive electrode and the negative electrode, but were not so severe that they would have immediate influence on the battery performance was indicated as “Δ”.

After the presence or absence of wrinkles on the housing was checked, the battery was disassembled. The condition around the positive electrode current collector and the condition around the negative electrode current collector were checked. The condition where no damage was detected at all on the positive and negative electrode current collectors and the positive and negative electrode leads was ranked as “A”. The condition where a partial defect was detected on at least one of the positive and negative electrode current collectors and the positive and negative electrode leads, but the electrical connection between the current collector and the lead was not damaged at all was ranked as “B”. The condition where critical damage resulting in a complete cut was detected on at least one point on at least one of the positive and negative electrode current collectors and the positive and negative electrode leads was ranked as “C”.

The above evaluation results are shown in Table 6.

TABLE 6

| | | | Negative electrode | | | | | | |
|---|---|---|---|---|---|---|---|---|---|
| | Positive electrode | | current collector | | Bending test | | | | |
| | current collector | | Surface roughness | Surface roughness | Internal resistance | Internal resistance | Capacity | Condition around | Wrinkles |
| Battery | Rz1 | Rz2 | Rz1 of gloss | Rz2 of mat | before bending | after bending | retention | negative electrode | on |
| No. | (μm) | (μm) | surface (μm) | surface (μm) | test (Ω) | test (Ω) | rate (%) | current collector | housing |
| 3 | 2.1 | 2.1 | 0.2 | 5 | 1.2 | 1.2 | 98.2 | A | ◯ |
| 55 | 0.3 | 0.3 | 0.2 | 5 | 1.2 | 1.2 | 98.4 | A | ◯ |
| 9 (Com.) | 2.1 | 2.1 | 0.4 | 0.4 | 1.2 | 7.4 | 50.2 | C | X |
| 56 (Com.) | 0.4 | 0.4 | 0.4 | 0.4 | 1.2 | 6.5 | 57.9 | C | X |
| 57 | 0.3 | 0.3 | 0.4 | 0.4 | 1.2 | 2.2 | 86.8 | B | Δ |
| 58 | 0.2 | 0.2 | 0.4 | 0.4 | 1.2 | 2.1 | 88.2 | B | Δ |
| 59 | 0.05 | 0.05 | 0.4 | 0.4 | 1.2 | 2.0 | 89.6 | B | Δ |

Table 6 shows that merely by adjusting the surface roughness Rz1 of the outside surface of the positive electrode current corrector to 0.05 to 0.3 μm, the occurrence of wrinkles on the housing can be suppressed. This is presumably because the slippage between the positive electrode current collector and the housing was improved. Table 6 further shows that rather than by adjusting the surface roughness Rz1 of the outside surface of the positive electrode current corrector to 0.05 to 0.3 μm, by adjusting the surface roughness Rz1 of the outside surface of the negative electrode current corrector to 0.05 to 0.3 μm, a more remarkable can be obtained.

### INDUSTRIAL APPLICABILITY

The thin flexible battery of the present invention is excellent in bending resistance and suitably applicable as a driving power source or backup power source for portable equipment and small-sized electronic equipment such as a biological information measuring device which is used while being attached to a living body.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1 Negative electrode current collector

2 Negative electrode active material layer

3 Negative electrode lead

4 Positive electrode current collector

5 Positive electrode active material layer

6 Positive electrode lead

7 Electrolyte layer

8 Housing

11 Negative electrode

12 Positive electrode

13 Electrode group

21 Thin flexible battery

31 Jig

1. A thin flexible battery comprising:
an electrode group which includes
a positive electrode including a sheet-like positive electrode current collector, and a positive electrode active material layer adhering to one surface of the positive electrode current collector,
a negative electrode including a sheet-like negative electrode current collector, and a negative electrode active material layer adhering to one surface of the negative electrode current collector, and
an electrolyte layer interposed between the positive electrode active material layer and the negative electrode active material layer; and
a housing accommodating the electrode group, wherein
the housing includes a barrier layer, and resin layers formed on both surfaces of the barrier layer,
the other surface of the positive electrode current collector and the other surface of the negative electrode current collector are in contact with the resin layer at an inner side of the housing, and
said the other surface of at least one of the positive electrode current collector and the negative electrode current collector has a surface roughness Rz1 of 0.05 to 0.3 μm.

2. The thin flexible battery in accordance with claim 1, wherein
the negative electrode active material layer is a sheet-like lithium metal or lithium alloy, and
the one surface of the negative electrode current collector in contact with the lithium metal or lithium alloy, has a surface roughness Rz2 of 0.4 to 10 μm.

3. The thin flexible battery in accordance with claim 2, wherein
the sheet-like lithium metal or lithium alloy has a thickness of 10 to 100 μm, and
the negative electrode has a capacity per unit area of 1.0 to 10 mAh/cm².

4. The thin flexible battery in accordance with claim 1, wherein the negative electrode current collector comprises at least one selected from the group consisting of copper, nickel, titanium, and stainless steel.

5. The thin flexible battery in accordance with claim 1, wherein
the negative electrode current collector is a copper foil,
the negative electrode current collector has a thickness of 5 to 30 μm,
the negative electrode current collector has an elongation percentage of 5 to 15%.

6. The thin flexible battery in accordance with claim 1, wherein
the positive electrode active material layer is a material mixture layer comprising: a positive electrode active material of at least one selected from the group consisting of manganese dioxide, fluorinated carbon, lithium-containing composite oxides, metal sulfides, and organic sulfur compounds; and a binder,
the one surface of the positive electrode current collector in contact with the material mixture layer, has a surface roughness Rz3 of 0.05 to 0.5 μm.

7. The thin flexible battery in accordance with claim 1, wherein the positive electrode current collector comprises at least one selected from the group consisting of silver, nickel, palladium, gold, platinum, aluminum, and stainless steel.

8. The thin flexible battery in accordance with claim 1, wherein the barrier layer is an aluminum layer.

9. The thin flexible battery in accordance with claim 1, wherein the resin layer at the inner side of the housing comprises at least one selected from the group consisting of polyolefin, polyethylene terephthalate, polyamide, polyurethane, and ethylene-vinyl acetate copolymer.

10. (canceled)

11. A thin flexible battery comprising:
an electrode group which includes
a positive electrode, two negative electrodes on both sides of the positive electrode, and electrolyte layers each interposed between the positive electrode and the negative electrode,
the positive electrode including a sheet-like positive electrode current collector, and positive electrode active material layers on both surfaces of the positive electrode current collector,
the negative electrodes each including a sheet-like negative electrode current collector, and a negative electrode active material layer on one surface of the negative electrode current collector facing the electrolyte layer; and
a housing accommodating the electrode group, wherein
the housing includes a barrier layer, and resin layers formed on both surfaces of the barrier layer,
the other surfaces having no negative electrode active material layer of the negative current collectors are in contact with the resin layer at an inner side of the housing, and
at least one of said the other surfaces in contact with the resin layer of the negative electrode current collectors has a surface roughness Rz 1 of 0.05 to 0.3 μm.

12. The thin flexible battery in accordance with claim 11, wherein
the negative electrode active material layer is a sheet-like lithium metal or lithium alloy, and
the one surface of the negative electrode current collector in contact with the lithium metal or lithium alloy, has a surface roughness Rz2 of 0.4 to 10 μm.

13. The thin flexible battery in accordance with claim 12, wherein
the sheet-like lithium metal or lithium alloy has a thickness of 10 to 100 μm, and
the negative electrode has a capacity per unit area of 1.0 to 10 mAh/cm².

14. The thin flexible battery in accordance with claim 11, wherein the negative electrode current collector comprises at least one selected from the group consisting of copper, nickel, titanium, and stainless steel.

15. The thin flexible battery in accordance with claim 11, wherein
the negative electrode current collector is a copper foil,
the negative electrode current collector has a thickness of 5 to 30 μm,
the negative electrode current collector has an elongation percentage of 5 to 15%.

16. The thin flexible battery in accordance with claim 11, wherein
the positive electrode active material layer is a material mixture layer comprising: a positive electrode active material of at least one selected from the group consisting of manganese dioxide, fluorinated carbon, lithium-containing composite oxides, metal sulfides, and organic sulfur compounds; and a binder,
the one surface of the positive electrode current collector in contact with the material mixture layer, has a surface roughness Rz3 of 0.05 to 0.5 μm.

17. The thin flexible battery in accordance with claim 11, wherein the positive electrode current collector comprises at least one selected from the group consisting of silver, nickel, palladium, gold, platinum, aluminum, and stainless steel.

18. The thin flexible battery in accordance with claim 11, wherein the barrier layer is an aluminum layer.

19. The thin flexible battery in accordance with claim 11, wherein the resin layer at the inner side of the housing comprises at least one selected from the group consisting of polyolefin, polyethylene terephthalate, polyamide, polyurethane, and ethylene-vinyl acetate copolymer.

20. A thin flexible battery comprising:
an electrode group which includes
at least one positive electrode including a sheet-like positive electrode current collector, and a positive electrode active material layer on the positive electrode current collector,
at least one negative electrode including a sheet-like negative electrode current collector, and a negative electrode active material layer on the negative electrode current collector, and
at least one electrolyte layer interposed between the positive electrode active material layer and the negative electrode active material layer; and
a housing accommodating the electrode group, wherein
the housing includes a barrier layer, and resin layers formed on both surfaces of the barrier layer,
the electrode group has two opposed principal surfaces, one of the principal surfaces being an exposed surface where a surface having no positive electrode active material layer of the positive electrode current collector or a surface having no negative electrode active material layer of the negative electrode current collector is exposed, and being in contact with the resin layer at an inner side of the housing, and
the exposed surface has a surface roughness Rz1 of 0.05 to 0.3 μm.

21. The thin flexible battery in accordance with claim 20, wherein
the negative electrode active material layer is a sheet-like lithium metal or lithium alloy, and
the one surface of the negative electrode current collector in contact with the lithium metal or lithium alloy, has a surface roughness Rz2 of 0.4 to 10 μm.

22. The thin flexible battery in accordance with claim 21, wherein
the sheet-like lithium metal or lithium alloy has a thickness of 10 to 100 μm, and
the negative electrode has a capacity per unit area of 1.0 to 10 mAh/cm².

23. The thin flexible battery in accordance with claim 20, wherein the negative electrode current collector comprises at least one selected from the group consisting of copper, nickel, titanium, and stainless steel.

24. The thin flexible battery in accordance with claim 20, wherein
the negative electrode current collector is a copper foil,
the negative electrode current collector has a thickness of 5 to 30 μm,
the negative electrode current collector has an elongation percentage of 5 to 15%.

25. The thin flexible battery in accordance with claim 20, wherein
the positive electrode active material layer is a material mixture layer comprising: a positive electrode active material of at least one selected from the group consisting of manganese dioxide, fluorinated carbon, lithium-containing composite oxides, metal sulfides, and organic sulfur compounds; and a binder,
the one surface of the positive electrode current collector in contact with the material mixture layer, has a surface roughness Rz3 of 0.05 to 0.5 μm.

26. The thin flexible battery in accordance with claim 20, wherein the positive electrode current collector comprises at least one selected from the group consisting of silver, nickel, palladium, gold, platinum, aluminum, and stainless steel.
